(19) United States
(12) Patent Application Publication
(10) Pub. No.: US 2011/0132695 A1
(43) Pub. Date: Jun. 9, 2011

(54) Elevator Apparatus Yielding No Reverse Rope Bend

(75) Inventors: Amer Aziz, Collierville, TN (US); Dustin Bobbit, Byhalia, MS (US); Gary Hooper, Rathdrum, ID (US); Donnie Bacak, Henderson, NV (US); Jeff Duvall, Olive Branch, MS (US)

(73) Assignee: ThyssenKrupp Elevator Capital Corporation, Troy, MI (US)

(21) Appl. No.: 12/963,960

(22) Filed: Dec. 9, 2010

Related U.S. Application Data
(60) Provisional application No. 61/267,990, filed on Dec. 9, 2009.

(51) Int. Cl. B66B 11/04; B66B 11/00

(52) U.S. Cl. 187/266

(57) ABSTRACT

Provided is an elevator apparatus that may be mounted horizontally in an upper portion of an elevator hoistway. Such an elevator apparatus may comprise a drive machine, a deflector sheave, a support frame, and a roping system. The roping system may be configured to eliminate reverse rope bend to improve the rope life of the system.

### PRIORITY

This application claims priority to U.S. Provisional Patent Application Ser. No. 61/267,990, filed Dec. 9, 2009, entitled “Elevator Apparatus Yielding No Reverse Rope Bend”, the disclosure of which is herein incorporated by reference in its entirety.

### FIELD

Embodiments of the present invention relate, in general, to an elevator apparatus, and, in particular, to an elevator apparatus capable of being mounted horizontally in a hoistway and yielding no reverse bend in the system's roping.

### BACKGROUND

Traditionally, elevator lifting and control apparatus may be installed in a separate machine room constructed on the roof directly above an elevator hoistway. Installation of a lifting device in the hoistway itself may provide several advantages for a building owner in that overall space requirements may be reduced.

Installing an elevator lifting and control device into a hoistway, however, may present some challenges for an elevator manufacturer. For example, installation of a lifting apparatus within an industry standard hoistway may require more overhead, i.e., the vertical distance in a hoistway from a top landing sill to a hoistway shaft ceiling. To reduce this overhead, the apparatus may be mounted horizontally, instead of vertically, so the hoistway does not break the line of the roof. Mounting a lifting device horizontally, however, may introduce a reverse bend in an elevator's roping system. Such a reverse bend may reduce elevator rope life.

Thus, it may be advantageous to provide an elevator lifting and control apparatus capable of horizontal installation while also having a roping system that does not yield to reverse bending.

### BRIEF DESCRIPTION OF THE DRAWINGS

The accompanying drawings incorporated in and forming a part of the specification illustrate several aspects of the present disclosure, and together with the description serve to explain the principles of the invention; it being understood, however, that the described embodiments are not limited to the precise arrangements shown. In the drawings, like reference numerals refer to like elements in the several views. In the drawings:

FIG. 1 is a plan view of one version of an elevator apparatus mounted horizontally within an elevator shaft.

FIG. 2 is a perspective view of the elevator apparatus of FIG. 1.

FIG. 3 is a perspective view of the elevator apparatus of FIG. 1 shown mounted within a hoistway.

FIG. 4 is a perspective view of the elevator apparatus of FIG. 1 shown mounted within a hoistway.

FIG. 5 is a more detailed perspective view of one version of a mounting system for the elevator apparatus of FIG. 1.

FIG. 6 is a partial perspective view of the elevator apparatus of FIG. 1 having a hinged drive sheave, where the hinged drive sheave is shown in a partially released position.

FIG. 7 is a partial perspective view of the elevator apparatus of FIG. 1 shown with the hinged drive sheave in a partially released position.

FIG. 8 is a perspective view of an alternate embodiment of the elevator apparatus employing a hinged frame.

FIG. 9 is a plan view of the elevator apparatus of FIG. 8.

FIG. 10 is a partial perspective view of the elevator apparatus of FIG. 8 where the hinged portion is shown lowered relative to a stationary position of the frame.

### DETAILED DESCRIPTION

Embodiments described in this disclosure comprise an elevator apparatus for lifting and/or lowering an elevator car. In one version, the elevator apparatus is mounted horizontally in an elevator hoistway and includes a roping system lacking a reverse bend to increase the useful life of the system. As used herein, “reverse bend” means that the elevator hoisting rope or other hoisting member is subjected to bending over sheaves in different directions such that the strain in the wires alternates from tension to compression. As is well known in the art, such reverse bending may be destructive of the life of the elevator rope or other hoisting member, particularly a wire rope.

The elevator apparatus further includes a hinged drive machine that is releasable to allow for maintenance or replacement of drive system components.

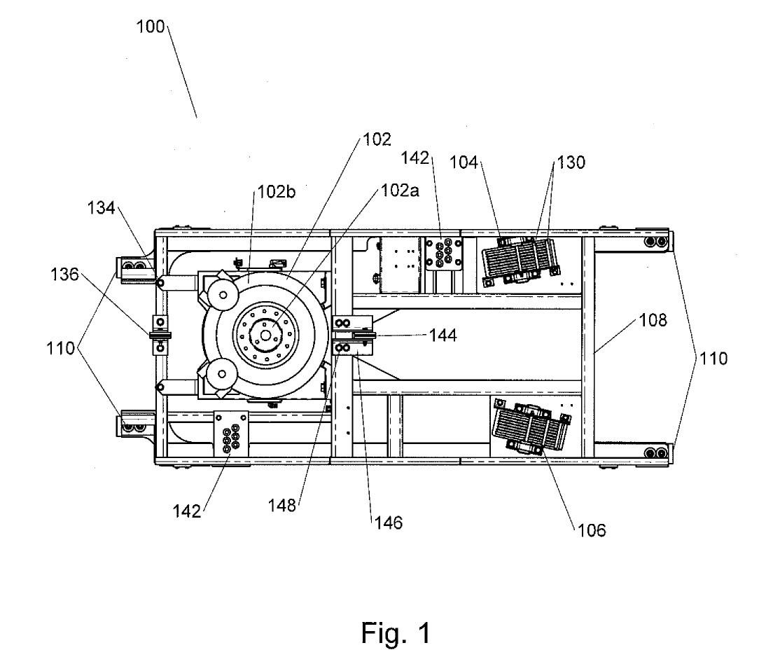

Referring to FIG. 1, one version of an elevator apparatus 100 is shown, where the elevator apparatus 100 is configured as a machineroom-less elevator system that does not require the presence of an elevator machine room separate from the elevator shaft. The elevator apparatus 100 comprises a number of components including a drive machine 102, a deflector sheave 104, and a supporting frame 108. In one version, the drive machine 102 is affixed to the supporting frame 108 with a hinge system that allows for the drive machine to pivot on the hinge system for maintenance, installation, or removal of the drive machine 102 and/or other suitable components. Illustrated versions are shown with a traction elevator system, however any suitable type of elevator may be used with the system described herein including drum elevators and linear motor elevators. It will also be appreciated that the elevator apparatus may be positioned in the lower part of an elevator shaft in a horizontal configuration or along the side of an elevator shaft in a vertical configuration. It will be appreciated that the apparatus 100 may include electrical boxes, such as a box for low voltage components and a box for high voltage components. The box for high voltage components may serve as the termination for the leads from the drive machine 102 and brake coils above with a choke to regulate line interference. The low voltage box may be configured for terminating low voltage components, encoders, brake switches, and may include printer circuit boards for regulating the encoder.

The drive machine 102 includes a drive sheave 102a and a body 102b. Body 102b may further comprise a motor and a brake to drive rotation of drive sheave 102a and to control the speed of an associated elevator car, respectively. As shown in FIG. 1, the drive sheave 102a may be positioned above drive body 102b. The drive machine 102 is positioned substantially horizontally such that the axis of rotation of the drive machine 102 is substantially parallel to the central axis of an elevator shaft and normal to the position of the supporting frame 108.

The elevator apparatus 100 includes one or a plurality of deflector sheaves 104, 106. For example, the version of the elevator apparatus of FIG. 1 is shown with two deflector sheaves 104 and 106, which may be substantially identical in configuration, and are configured to transition an elevator hoisting rope 200, or other hoisting member, from a generally horizontal position to a generally vertical position. Deflector sheaves 104, 106 may be positioned, as shown, such that the axis of rotation of the deflector sheaves 104, 106 is normal to the axis of rotation of the drive sheave 102a. As shown, the deflector sheaves 104, 106 may be positioned in generally the same plane as the drive sheave 102a such that the rope 200 is generally horizontal, however, other configurations are possible such as where the drive sheave 102a is above the deflector sheaves 104, 106 such that the rope 200 slopes downward from the drive sheave 102a to the deflector sheaves 104, 106.

As shown in FIG. 1, the rope 200 is wrapped around the drive machine 102, passes over the deflector sheaves 104, 106, and descends into the elevator hoistway. In the illustrated version the deflector sheaves are passive sheaves attached with a bolt or other suitable coupling to the supporting frame 108. As shown in FIG. 1, the deflector sheaves 104, 106 may be placed a sufficient distance from the drive sheave 102a to allow the rope or band to twist, for example, 90 degrees in a configuration with a sufficiently low fleet angle to prevent the rope 200 from disengaging from the drive sheave 102a and/or the deflector sheaves 104, 106. The deflector sheaves may include guides 130 to help retain the rope on the deflector sheaves 104, 106 during emergency stops when the rope 200 may go slack.

The frame 108 supports the drive machine 102 and deflector sheaves 104,106, where the drive machine 102 and deflector sheaves 104, 106 may be integral, fixedly attached, or detachably coupled to the mounted to frame 108. In one version, the frame 108 includes at least one support member 110, which is configured to secure the frame 108 to the hoistway. Elevator apparatus 100 may comprise any number of support members 110 as will be apparent to one of ordinary skill in the art. For example, FIG. 1 shows four support members 110 which may be bolted or otherwise coupled with a hoistway during installation. Support members 110 may be secured fully or partially within a hoistway to a hoistway wall, beam, elevator guide rail, or other suitable location. The support members 110 may be adjustable supports, such as where the support members have a telescoping feature or extension to allow the frame 108 to fit a wide range of hoistway dimensions, or any other suitable support. The frame 108 may be configured from sheet metal, structural steel, casting, polymer, composite material, and/or any other suitable material.

In an alternate embodiment (not shown), the frame 108 may be bracketed or otherwise attached to the rails extending vertically within the hoistway. In this configuration the rails may be installed before bringing the apparatus 100 up through the hoistway and attaching the frame 108 to the top of the rails. The frame 108 may be made of multiple separate components where, for example, one portion of the frame 108 is attached to a pair of rails and a separate part of the frame 108 is attached to a second pair of rails and is then bolted or otherwise attached to the first frame portion. The frame 108 may be mounted on one or a plurality of the rails within the hoistway.

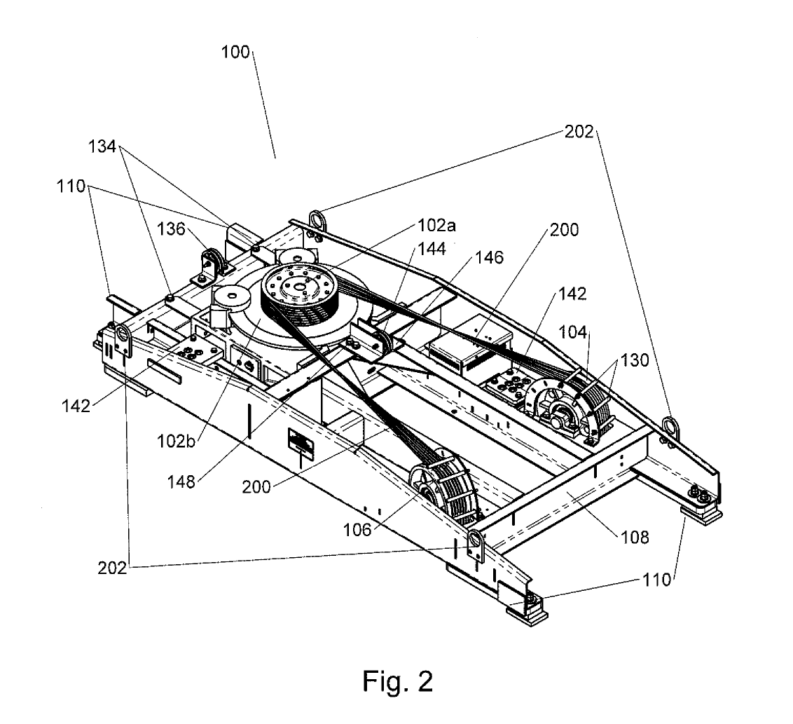

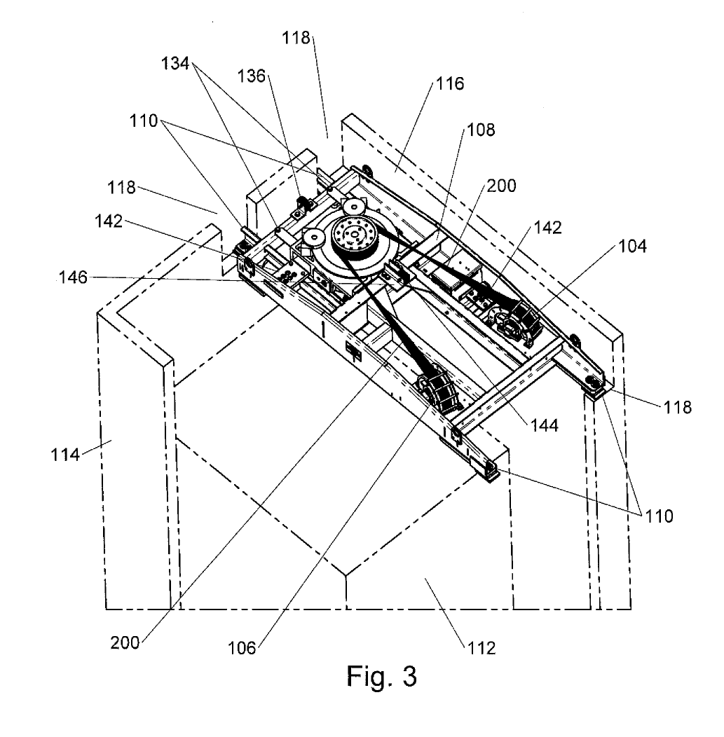

The frame 108, in the illustrated version, includes an eyelet or hook 202 configured to assist in the installation of the apparatus 100. For example, FIG. 2 illustrates four hooks 202, which may be used to couple with a lifting apparatus, such as a crane, to move or transport an elevator apparatus 100 or to position an elevator apparatus 100 into an open portion of an elevator hoistway. For example, referring to FIG. 3, elevator apparatus 100 may be lowered or positioned via hooks 202 into an open portion 116 in an upper portion of an elevator hoistway 114 above an elevator car 112. In this manner, the support members 110 of frame 108 may be lowered into recesses 118 formed within an open portion 116 of hoistway 114. Hoisting points of the frame 108 may be positioned at the center of gravity such that a single hoist point may be used to lift and install the frame 108. The frame 108 further includes hitch plates 142 that serve as rope 200 termination points. Accordingly, the apparatus may be lowered from above onto the support members 110, or may be raised from below within the elevator shaft and set onto the support members.

The rope 200 includes any suitable single cord, band, or line or plurality of cords, bands, or lines in any suitable arrangement or configuration. The rope 200, as shown, may include a plurality of individual rope strands associated with grooves within the drive sheave 102a and deflector sheaves 104, 106. The grooves in the drive sheave 102a and deflector sheaves 104, 106 may have sufficient depth and dimensions to prevent slippage of the rope 200. The type and number ropes used may vary as a function of the system weight. Rope 200 may be wound around drive machine 102, and in particular drive sheave 102a, to suspend an elevator car (not shown) and a counterweight (not shown). As shown, the first end of the rope 200 is be directed by deflector sheave 104 to suspend an elevator car and the second end of rope 200 is directed by a deflector sheave 106 to suspend a counterweight. The counterweight may be positioned with respect to the elevator car as is well known in the art. In this manner, rotation of drive machine 102, and in particular drive sheave 102a, raises and lowers an elevator car while correspondingly raising and lowering a counterweight. The position and operation of the drive machine 102 and deflector sheaves 104,106 allows an elevator car to be raised and lowered without subjecting rope 200 to reverse bend, where such reverse bend may reduce the useful life of rope 200.

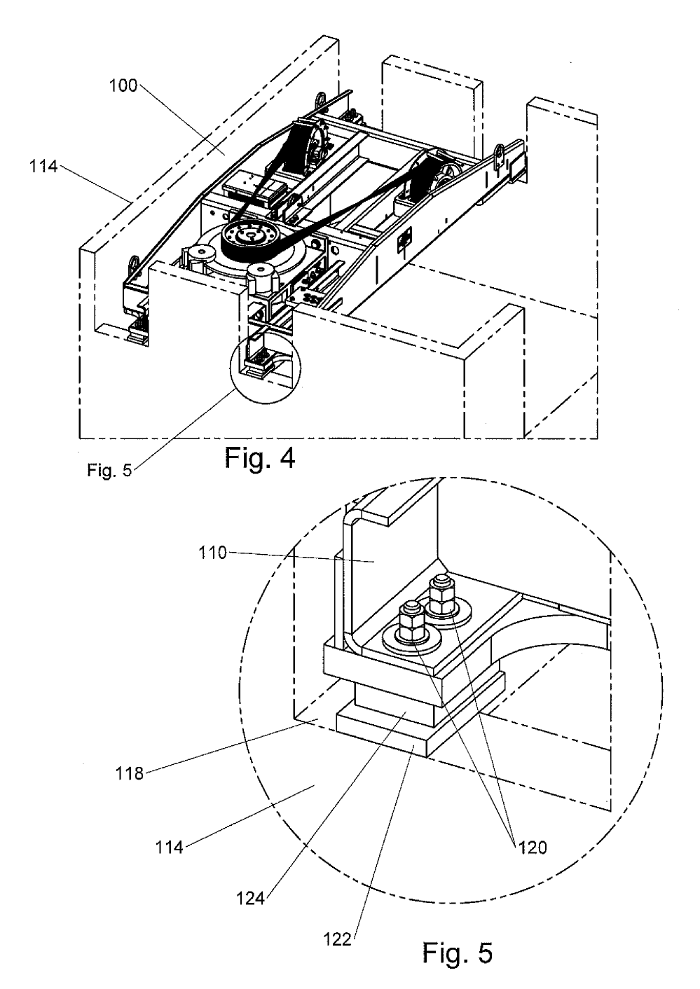

Referring to FIGS. 4-5, after positioning elevator apparatus 100, frame 108 may be secured via its support members 110 to a hoistway, to the elevator rails, and/or to any other suitable location such as a beam. Specifically, FIG. 4 shows the support members 110 secured to a recess 118 in a hoistway 114 wall. As shown in FIG. 4, the support members 110 are secured to recess 118 by welding a weld plate 122 to the recess 118. One or a plurality of fasteners 120 may attach the weld plate 112 and an isolation plate 124 to the frame 108 such that the frame 108 may be removed from the weld plate 122 and hoistway 114 by detaching the fasteners 120. Any suitable number and type of fasteners 120 may be used and any suitable means of attaching the frame 108 to the recess 118, hoistway 114, and/or rails is contemplated. The isolation plate 124 may be a damping member, such as rubber or fiber reinforced rubber, configured to reduce the transmission of vibrations from the drive machine 120 to the hoistway 114.

In one version, the apparatus 100 may be used to facilitate the placement of other elevator components once positioned within the hoistway wall 114. For example, once the frame 108 is secure in the recesses 118, the installation of the elevator rails may be indexed off of the overhead structure with drop line targets using locating tools.

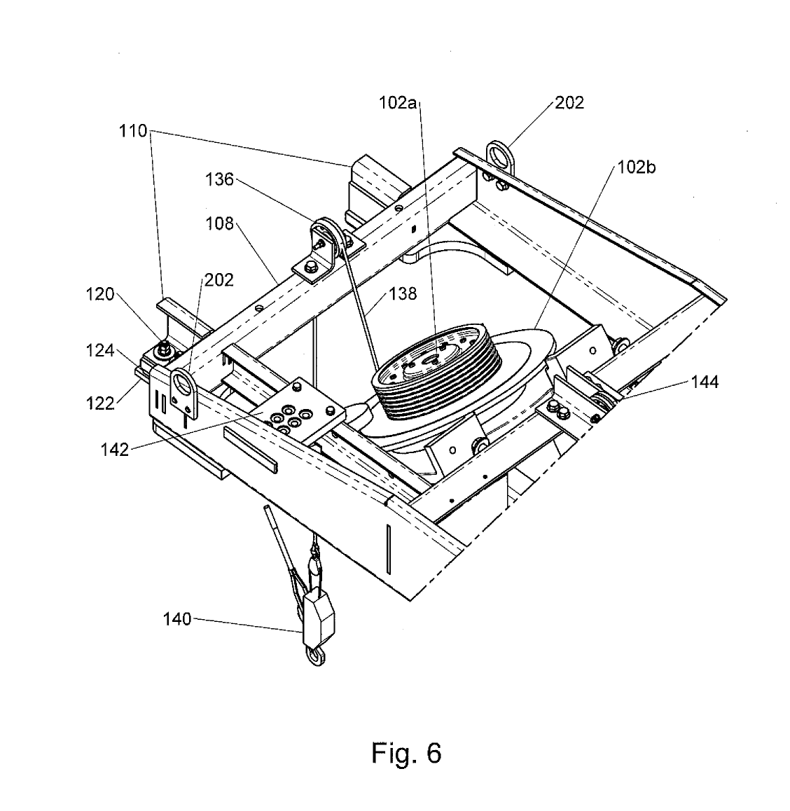

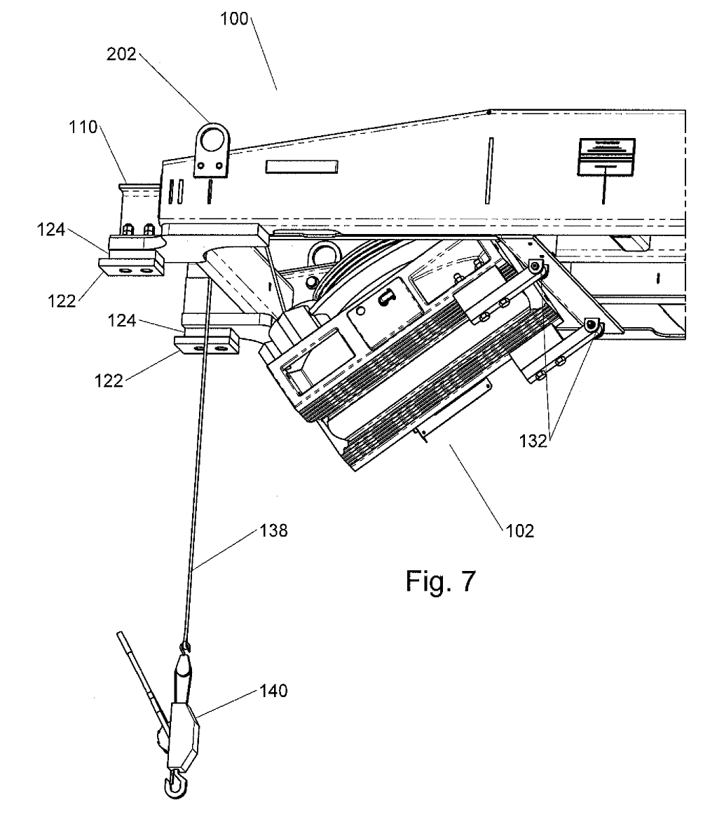

FIGS. 6-7 illustrate one version of the apparatus 100 having a hinge system for lowering, installing, and/or removing all or a portion of the apparatus 100. When placed at the top of an elevator hoistway it may be advantageous to provide a means of accessing the components, and in particular the drive machine 102, of the apparatus in a safe and efficient manner. Components such as service brakes, brake switches, and encoders may need to be replaced at regular intervals. As illustrated in FIG. 7, the apparatus 100 may include one or a plurality of hinges 132 coupling the drive machine 102 with the frame 108. During operation, the drive machine 102 may include one or a plurality of bolts 134 (FIGS. 1-3), or other suitable fastener, that couple the drive machine 102 to the frame 108. The bolts 134 may be removable such that removal of the bolts 134 allows the drive machine 102 to pivot about the hinges to provide access to the drive machine 102 from within the hoistway. During a maintenance period, the bolts 134 are removed such that the drive machine 102 may be accessed easily from below the apparatus 100.

The apparatus 100 further includes a pulley 136 fixedly attached to the frame 108 that, in combination with a cable 138, is configured to allow for the controlled release of the drive machine 102 as it pivots about the hinges 132. Prior to removing the bolts 134, the cable 138 is wound over the pulley 136 and is detachably coupled to the movable drive machine 102 with a pin, hook, or other suitable fastener. The bolts 134 are then removed while a tension member 140 provides sufficient tension to the cable 138 to secure the movable end of the drive machine 102. The tension member 140 may then lower the free end of the drive machine 102 in a controlled manner to allow for maintenance or replacement of components associated with the apparatus 100. When maintenance is complete, the tension member 140 may be used to return the drive machine 102 to its operation position, the bolts 134 may be replaced, and the cable 138 may be removed from the frame 108.

The apparatus 100 may further include a second pulley 144, as shown in FIGS. 1-3, attached to a removable plate 146 that is attached to the frame 108 with one or a plurality of fasteners 148. The second pulley 144 is configured to allow removal of the drive machine 102 after it has been lowered using the first pulley 136. Once the drive machine 102 has been lowered, the removable plate 146 may be removed, rotated 180 degrees, and is then refastened to the frame 108 using the fasteners 148. In this position the second pulley 144 is now positioned over the drive machine 102. The cable 138 may then be wound around the second pulley 144 with one end attached to the drive machine 102 and the other end associated with the tension member 140. The hinges 132 may then be removed such that the drive machine 102 is held only by the cable 138. The tension member 140 may then be used to lower the drive machine 102 for removal from the frame 108. In this manner, the first pulley 136 may be used for routine maintenance of the apparatus 100, or may be used in combination with the second pulley 144 for complete removal of the drive machine 102. It will be appreciated that performing the disclosed steps in reverse may be used to install a drive machine 102 on the frame 108, where the drive machine 102 may be lifted using the second pulley 144, the hinges 132 may then be secured, and the second pulley 136 may then be used to pivot the drive machine 102 into position before fastening the bolts 134.

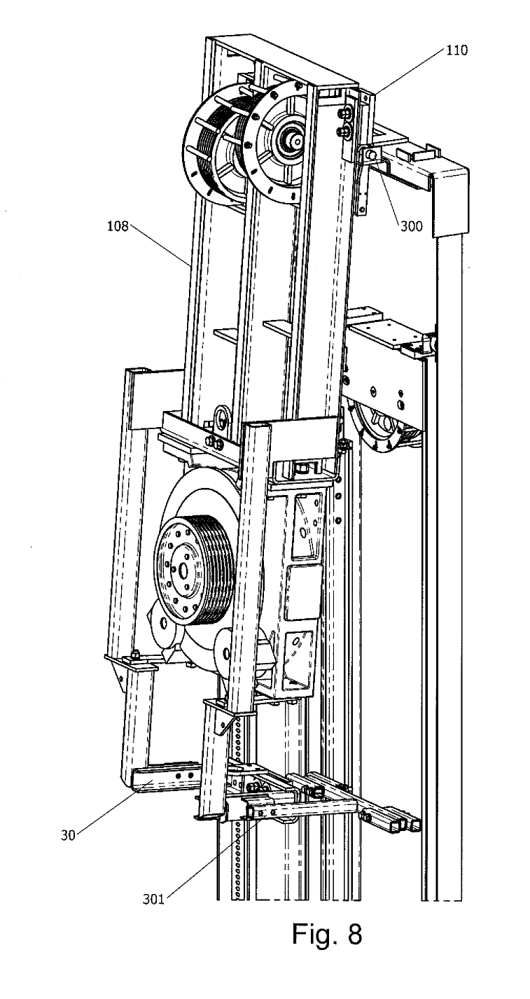

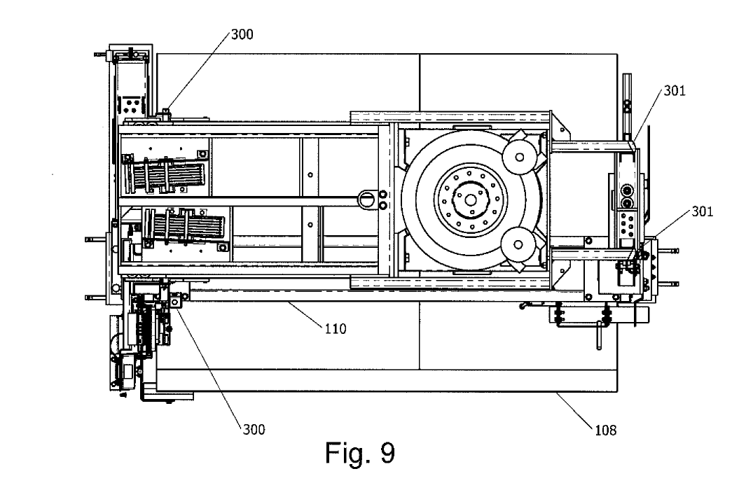

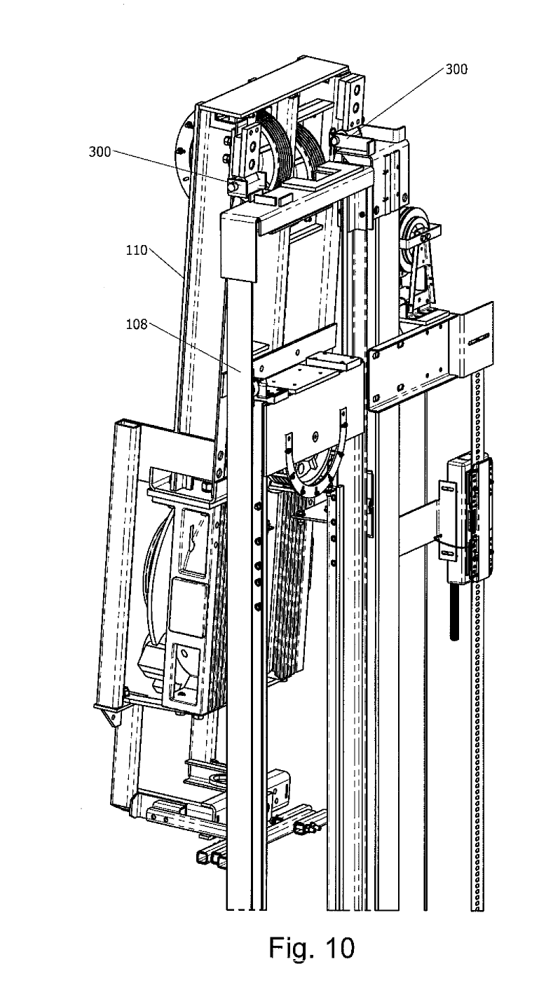

it will also be appreciated that the frame 108 may have an internal frame that allows all of the components, including the drive machine 102 and the deflector sheaves 104, 106, to be lowered for maintenance or removal as depicted in FIG. 8-FIG. 10. In this version, the frame 108 is hinged such that the entire frame 108 may be lowered for removal or maintenance. For example, at one end of the frame 108 the supporting members 110 may have a hinge system 300, such as a hinge or the like, allowing the frame 108 to pivot relative to the supporting members 110 and at the other end of the apparatus the supporting members 110 may have any suitable retention or locking members positioned as at 301 for attaching the frame 108 to the support members 110 and maintaining the frame 108 in a generally horizontal orientation to prevent pivoting of the frame 108 during normal operation of the elevator apparatus. It will be understood that the retention or locking members may be selectively releasable (such as by the withdrawal of a bolt or the like) so that upon release of the retention members the frame may be released from the supporting members 110 and can pivot on the hinge system 300 associated with the support members on the opposite side of the frame 108. In this system the supporting members remain coupled with the hoistway while the frame 108 is lowered for maintenance.

Systems having multiple hinged components, such as where the drive machine 102 is hinged as shown and the deflector sheaves 104, 106 are associated with a second hinge system, are also contemplated.

Further, the tension member 140 and cable 138 are shown by way of example only, where any controlled release system or method may be incorporated to allow for the efficient maintenance of the apparatus 100.

The apparatus 100 may also be fully or partially installed using versions of the system described herein. For example, the frame 108 may be positioned within an elevator hoistway and, once secure, the drive machine 102, or other suitable components, may be assembled using the systems described herein.

It will be appreciated that the apparatus may include one or a plurality of hinge systems, where the steps described may be applied to various sections of the frame 108 for installation, removal, and/or replacement of various components. Alternate methods of installing, removing, and/or accessing components of the apparatus 100 are also contemplated. For example, in one version (not shown) a series of threaded bolts pass through eyelets on the drive machine 102 and are attached to the frame 108. Nuts are threaded onto the bottom of the bolts to hold up the drive machine 102 when the bolts 134 are removed. The drive machine 102 may then be lowered on the threaded bolts by unscrewing the nuts, which allows the drive machine 102 to drop below the frame 108.

The versions presented in this disclosure are examples. Those skilled in the art can develop modifications and variants that do not depart from the spirit and scope of the elevator apparatus and lifting system. Thus, the scope of the invention should be determined by appended claims and their legal equivalents, rather than by the examples given.

We claim:

1. An elevator apparatus, comprising:
a. a frame, the frame being configured for placement within an elevator shaft;
b. a drive machine mounted horizontally on the frame, the drive machine comprising a motor, a brake, and a drive sheave;
c. a first deflector sheave mounted on the frame; and
d. a roping system, the roping system having a first end and a second end, the roping system being wound around the drive machine and directed by the first deflector sheave, such that the roping system has no reverse bend.

2. The elevator apparatus of claim 1, wherein the deflector sheave has a substantially vertical orientation.

3. The elevator apparatus of claim 1, further comprising a second deflector sheave mounted on the frame.

4. The elevator apparatus of claim 3, wherein the second deflector sheave is mounted adjacent the first deflector sheave and is configured to transition the roping system from a horizontal orientation to a vertical orientation.

5. The elevator apparatus of claim 1, wherein the elevator apparatus is a machineroom-less elevator apparatus.

6. The elevator apparatus of claim 5, wherein the elevator apparatus is positioned within an elevator shaft.

7. The elevator apparatus of claim 6, wherein the frame further comprises at least one attachment member configured for attachment to the elevator shaft.

8. The elevator apparatus of claim 1, wherein at least a portion of the roping system comprises a band.

9. The elevator apparatus of claim 1, wherein the first end of the roping system is coupled with an elevator car and the second end of the roping system is coupled with a counterweight.

10. An elevator apparatus, comprising:
a. a frame, the frame being configured for placement within an elevator shaft, the frame comprising a stationary portion configured for attachment to an elevator shaft and a moveable portion;
b. a hinge member connecting the stationary with the moveable portion to permit the moveable portion to pivot with respect to the stationary portion;
c. a drive machine mounted on the moveable portion, the drive machine comprising a motor and a drive sheave;
d. a first deflector sheave mounted on the frame; and
e. a roping system, the roping system having a first end and a second end, the roping system being wound around the drive machine and directed by the first deflector sheave.

11. The elevator apparatus of claim 10, wherein the moveable portion is configured to pivot relative to the stationary portion of the frame such that the drive machine is accessible from the elevator shaft.

12. The elevator apparatus of claim 10 further comprising a locking member, wherein the locking member is configured to retain the moveable portion in a horizontal position during operation of the elevator apparatus.

13. The elevator apparatus of claim 12, wherein the locking member is selectively releasable such that when the locking member is released the moveable portion is capable of pivoting downwardly to permit access to the drive machine.

14. The elevator apparatus of claim 10, wherein the moveable portion comprises substantially all of the frame and the stationary portion comprises at least one attachment member configured for attachment to an elevator shaft.

15. The elevator apparatus of claim 10 wherein the roping system the roping system has no reverse bend

16. A method of accessing an elevator apparatus comprising the steps of:
providing an elevator apparatus comprising;
a. a frame, the frame being configured for placement within an elevator shaft, the frame comprising a stationary portion configured for attachment to an elevator shaft and a moveable portion;
b. a hinge member connecting the stationary with the moveable portion to permit the moveable portion to pivot with respect to the stationary portion;
c. a drive machine mounted on the moveable portion, the drive machine comprising a motor and a drive sheave;
d. a first deflector sheave mounted on the frame; and
e. a roping system, the roping system having a first end and a second end, the roping system being wound around the drive machine and directed by the first deflector sheave; and
accessing the drive machine by pivoting the moveable portion relative to the stationary portion of the frame.

17. The method of claim 16 including the step of pivoting the moveable portion downwardly with respect to the stationary portion.

18. The method of claim 16, further comprising the step of securing the moveable portion to the stationary portion during normal operation of the elevator apparatus.

19. The method of claim 16, wherein the elevator apparatus further comprises a controlled release mechanism for lowering the moveable portion relative to the stationary member.

20. The method of claim 16, further comprising the step of lowering the moveable portion with the controlled release mechanism.

21. The method of claim 19, further comprising the step of raising the moveable portion from a lowered position to a position horizontally aligned with the stationary portion of the frame.

22. The method of claim 19, wherein the controlled release mechanism is configured to raise and lower the moveable portion relative to the stationary portion of the frame.
